(19) United States
(12) Patent Application Publication
(10) Pub. No.: US 2013/0247555 A1
(43) Pub. Date: Sep. 26, 2013

(54) Gravity Vortex Continuous Pipe Engine

(71) Applicant: Safwan Mohammad Ibrahim Al-Hussaini, Amman (JO)

(72) Inventor: Safwan Mohammad Ibrahim Al-Hussaini, Amman (JO)

(21) Appl. No.: 13/427,217

(22) Filed: Mar. 22, 2012

(51) Int. Cl. F03B 17/02

(52) U.S. Cl. 60/495

(57) ABSTRACT

The present invention relates to a donut-shaped power recycling device that harnesses wasted energy especially from Heating, Ventilation, Air Conditioning, and Refrigeration systems (HVACR) to be used as again as electrical and (or) mechanical energy. The device utilizes the effect of buoyancy due to gravity to generate a vortex that can pick up from the Coriolis Effect. The device comprises a donut-shaped stator, a donut-shaped rotor divided into a plurality of curved-shaped compartments; each having a rectangular-shaped opening at the outer circumference of the rotor; and wherein each of such openings has a plurality of power pickups, a cold gas inlet, a hot liquid inlet, a hot gas outlet, and a cold liquid outlet. The device can also have a bypass encountering the right hand side of said stator, and can further contain steam jets directed in an inclined angle towards said rotor.

### FIELD OF THE INVENTION

The present invention relates to power recycling devices, and more particularly to power recycling devices that harness wasted energy in Heating, Ventilation, Air Conditioning, and Refrigeration Systems (HVACR) systems to produce useful electrical or mechanical energy.

### BACKGROUND OF THE INVENTION

Limited number of energy resources is currently a problem facing the entire world. Thus, finding alternative sources of energy and energy recycling devices is now the focus of the world.

Thus, energy and power recycling devices are disclosed in the prior art. Among these devices, a machine operated by liquid Nitrogen supplied form a container connected to it through a radiator. Liquid Nitrogen evaporates at −195 C and absorbs heat through a radiator, the volume of gas expands and gas rushes into a movement box, starts replacing the liquid till it starts floating and moving up till it reaches the surface of the liquid, a cover then opens letting all the gas out of it, and consequently moving down under the effect of its weight till it reaches the bottom and the cover closes tightly once again, the gas replaces water to move the box up, and so on. The vertical movement is transferred into a rotational movement operating the electrical generator, or producing electricity directly from the vertical movement by coiling an insulated copper coil surrounding its vertical path.

In addition, another device have used a simple math model to estimate the energy requirements of a water vortex generator, followed by another model constructed for fluid mechanical analyses of water surface resistance and friction of a modified buoyancy engine. The final results demonstrated the feasibility of converting the potential energy of buoyancy into kinetic energy using floatation of conveyer mounted airtight containers, through which ultimately free energy can be acquired. Physical reasons were provided for the power saving in the high volume air transport using convergent air/water vortex generators, for which applicable designs were disclosed. Several criteria were identified for the optimum design of air bubble/stream release. To reduce water resistance and friction the generic buoyancy engine was modified by installing flow smoothing skirt panels on the containers to provide smooth continuous surfaces. Thin boundary layer of effervescent bubble filled water with specific gravity less than unity was considered for reducing friction force. An analytic evaluation identified an optimization of width/length ratio for the container configuration. Analyses also showed advantage of high speed engine operation to achieve higher power gain. A conceptual design was explored for a light gross weight mobile buoyancy engine using the entire vessel for water recirculation.

### SUMMARY OF THE INVENTION

It is therefore an object of the present invention to provide a device that overcome the above drawbacks, which would provide for a circular power recycling device that is efficient and can pick up from the Coriolis effect in order to produce useful electrical or mechanical energy.

The present invention relates to a power recycling device that harnesses the wasted power, especially the wasted power in Heating, Ventilation, Air Conditioning, and Refrigeration (HVACR) systems; in order to produce a useful electrical and (or) mechanical energy depending on the effect of buoyancy due to gravity.

The device of the present invention comprises a donut-shaped stator; a donut-shaped rotor divided equally into similar adjacent curved-shaped compartments by means of a plurality of engineered curved-shaped walls, wherein each of such compartments has a rectangular-shaped opening at the outer circumference of said rotor, and wherein such openings have attached window-type power pick-ups that are fixed by hinges to the horizontal edges of said rectangular openings. Said rotor lies inside said stator with a small between them; wherein such space can be maintained using any suitable means such as rollers. The device of the present invention also comprises a hot liquid inlet, a cold gas inlet, a hot gas outlet, and a cold gas outlet.

A bypass encircling the right-hand side of the stator with restricting means can be added to the device of the present invention; wherein the falling liquid inside the device in the down cycle go through such bypass rather than going down in the space between the stator and the rotor; and wherein the restricting means skims the liquid and forces it to go inside the bypass.

In addition, a plurality of steam jets can be added to the device of the present invention for increasing the efficiency of the present device; wherein such jets are directed towards the rotor through an inclined angle; and wherein such jets meet the device of the present invention at the stator. The stator has a plurality of internal one directional flappers at the areas where the jets meet the stator; wherein such flappers open and close automatically depending on the flow of steam to the system.

The device of the present invention is characterized in being donut-shaped and in its ability to pickup from the Coriolis Effect in order to be more efficient.

Therefore, as a first aspect of the invention, there is provided a circular device for energy recycling using gravity in buoyancy as a motivator when a gas source is released into a liquid; the device operating as a pump, the device comprising a casing consisting of a donut-shaped stator, a donut-shaped rotor engulfed by the stator with a space between them upheld by separation means, a hot liquid inlet, a cold liquid outlet, a cold gas inlet, and a hot gas outlet, wherein the rotor comprises a plurality of separating walls forming a plurality of adjacent curved compartments, each compartment having an opening to permit flow of liquid and gas inside and outside of the compartment, and wherein the opening has a window-type power pickups with hinges that open automatically when a generated liquid vortex is faster than the rotor and close automatically when the rotor is faster than the generated liquid vortex. Preferably, the compartments' openings are rectangular.

In accordance with a second embodiment of the invention, the device further comprises a bypass encircling a side of the stator with a plurality of restrictions for restricting the liquid from moving in certain directions.

In accordance with a third embodiment of the invention, the device further comprises a plurality of water or steam jets directed through a plurality of pipes with one way direction flappers.

In accordance with a forth embodiment of the invention, the device comprises all the elements of the first three embodiments.

Preferably, the device operates as a pump by allowing the gas to flow from an upper compartment to a lower compartment in a direction opposite to a direction of rotation of the rotor.

Preferably, the gas flows through a plurality of one-way valves directed towards the opposite direction of rotation of the rotor, and by opening liquid-only valves to allow liquid to flow into the upper compartments from the generated vortex through the compartments' openings.

Preferably, the device further comprises restrictors located at the upper inner walls of the stator for increasing efficiency of the pump by increasing pressure in the upper area.

Preferably, the device further comprises a circular plenum with one-way valves for enabling the gas to flow from the upper compartment to the lower compartment through valve scheduling into the compartments, and wherein the pipe is refrigerated and insulated from the liquid around it.

Preferably, the upper compartment and lower compartment valves are configured to open at the same time for carrying the gas from the upper compartment to the lower compartment.

Preferably, a non-insulated pipe connected to the hot side of the refrigeration system's compressor can be added to the opposite side of the rotor for heating the working liquid inside the stator and cools down such compressor and the hot side of the refrigeration system causing the device to become more efficient.

Preferably, the device further comprises a scheduled valve at each of the openings.

Preferably, the valve at the lower compartment's opening is configured to open to centrifuge the liquid inside the compartment and to close when all liquid inside the compartment is centrifuged outside, and wherein the gas inside the plenum is sucked out, for increasing efficiency of the pump.

Preferably, the separation means for maintaining the space between the stator and rotor comprise rollers.

Preferably, a hot liquid enters the device through the hot liquid inlet and a cold gas enters the device through the cold gas inlet, wherein the cold gas leaves the device after being heated up through the hot gas outlet, and the hot liquid leaves the device after being cooled down through the cold liquid outlet.

Preferably, the hot liquid inlet, cold liquid outlet, and cold gas inlet are located at the bottom area of the stator, and the hot gas outlet is located at the top area of the stator.

Preferably, the restrictions comprise carbon brushes.

Preferably, the plurality of restrictions skims the liquid to flow through the bypass in the rotor's down-cycle rather than flowing down through the compartments.

Preferably, the restrictions prevent the liquid from going back into the bypass after leaving it at the bottom of the device, or from going back into the falling compartment sides.

Preferably, the plurality of water or steam jets propels pressurized water steam, wherein the plurality of water or steam jets are directed through the plurality of pipes towards the outside body of the compartments through intentionally-directed angles, the pressurized steam propelled by the steam or water jets strengthening the vortex and extra heating the hot liquid.

Preferably, the flappers have carbon brushes at their ends, the flappers being mechanically connected to steam jets valves' making such valves open in order to propel the pressurized steam when such flappers are open, and close in order not to propel the pressurized steam when such flappers are closed.

Preferably, the flappers open when pressurized steam is being propelled through the directing pipes, or when the liquid inside the vortex attempts to move in the opposite direction of the rotor's rotation, and close when there is no steam propelled through the directing pipes or when the liquid inside the vortex is moving in the same direction of the rotation of the rotor.

### BRIEF DESCRIPTION OF THE DRAWINGS

FIG. 1 illustrates a perspective view for the internal configuration of a gravity vortex continuous type engine configured according to a first preferred embodiment of the invention.

FIG. 2 illustrates a perspective view for the internal configuration of a gravity vortex continuous type engine configured according to a second preferred embodiment of the invention.

FIG. 3 illustrates a perspective view for a stator of a gravity vortex continuous type engine configured according to the second preferred embodiment of the invention.

FIG. 4 illustrates a perspective view for the internal configuration of a gravity vortex continuous type engine configured according to a third preferred embodiment of the invention.

FIG. 5 illustrates a perspective view for a gravity vortex continuous type engine configured according to a fourth preferred embodiment of the invention.

### DETAILED DESCRIPTION OF THE INVENTION

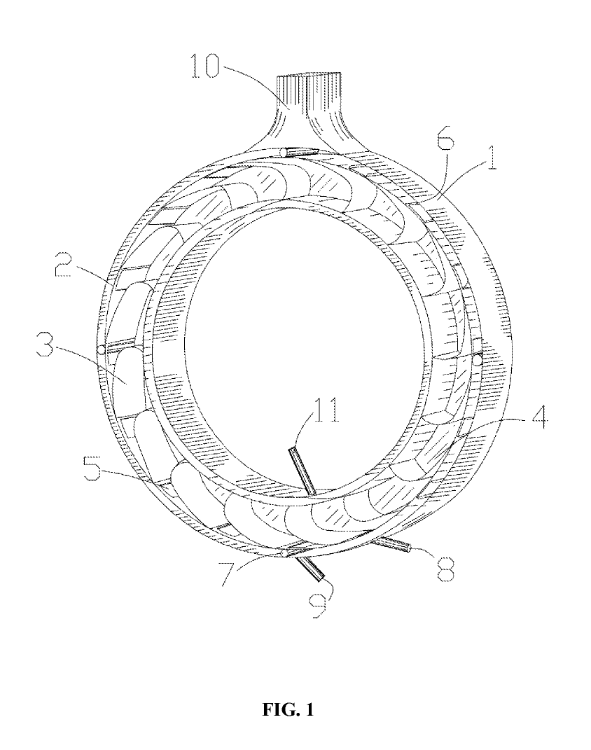

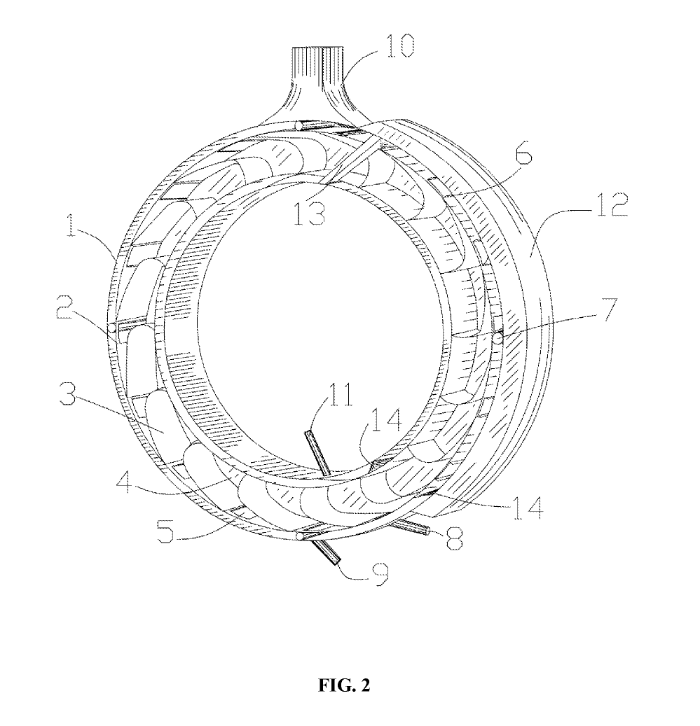

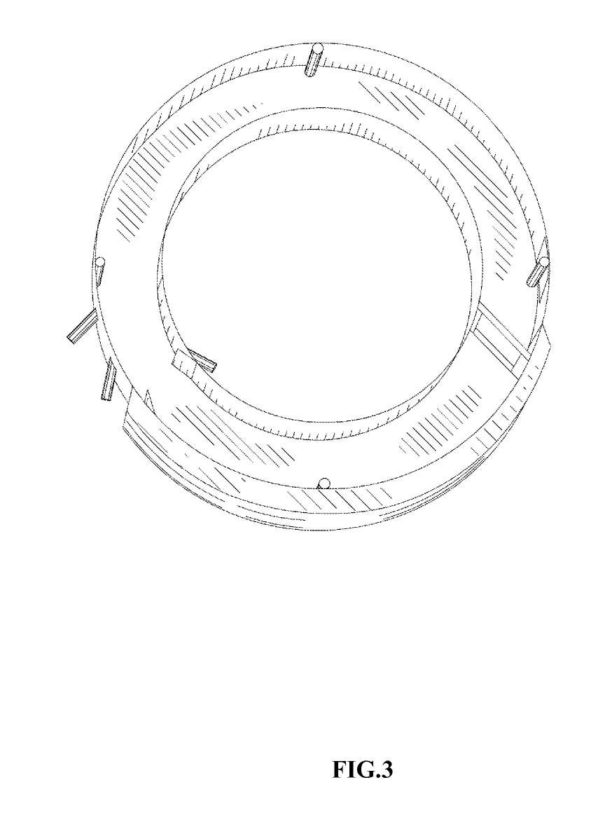

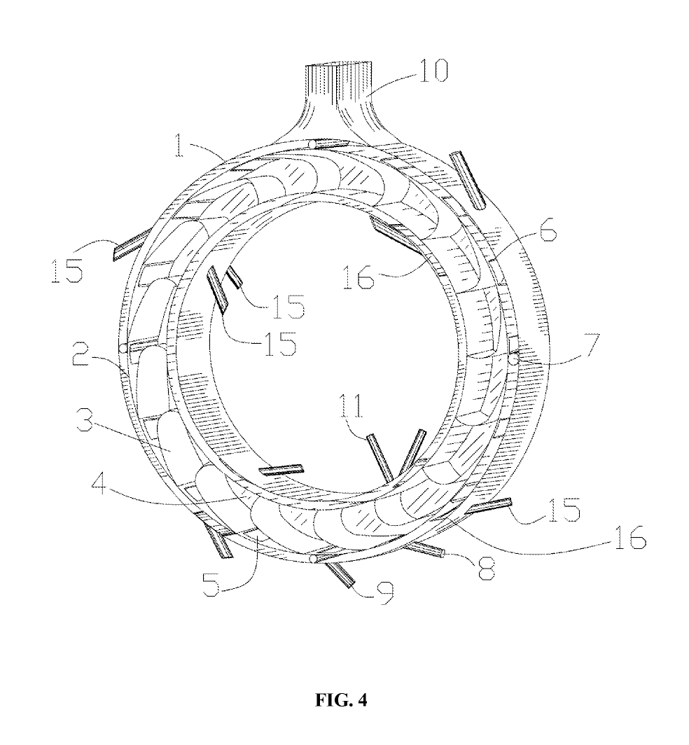

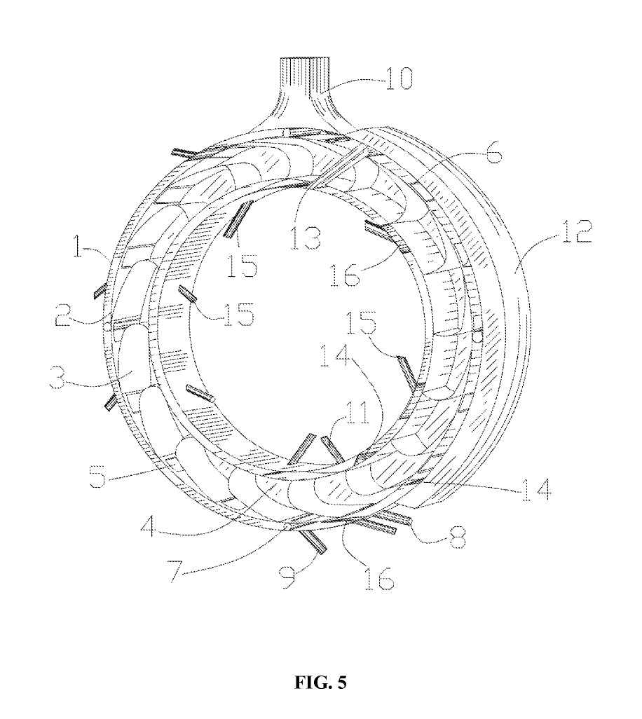

FIGS. 1, 2, 3, 4, and 5 illustrate four preferred embodiments to the present invention. The first preferred embodiment of the present invention comprises a donut-shaped stator 1; wherein such stator represents the casing of the device; and wherein a continuous donut-shaped rotor 2 is engulfed by such stator 1 with a small space between them. Such rotor is equally divided by separating walls 3 into a plurality of compartments 4; wherein such compartments are adjacent to each other such that the end of one compartment is the beginning of the adjacent compartment; and wherein such compartments 4 have rectangular openings 5 on the outside circumference of said rotor 2. Such openings 5 permit the flow of gas and liquid into and out of said compartments 4; wherein such openings have window-type power pickups 6 with hinges that open towards said stator 1; and wherein the cross section of such pickups is perpendicular to the direction of such openings 5. Such pickups are rigged to close automatically just before touching a plurality of rollers 7 or when said rotor 2 is faster than the created vortex, while such pickups open automatically when such vortex is faster than said rotor 2. Said rollers 7 maintain said space between said stator 1 and said rotor 2 in order to avoid collision between such stator and such rotor. Said separating walls 3 have curved engineered shape; wherein such shape adopts the high efficiency of such embodiment. The first preferred embodiment of the new modification also comprises a cool gas inlet 8 positioned at the bottom of said stator 1; and hot liquid inlet 9 preferably positioned at the bottom of said stator 1; as well as a gas outlet 10 placed at the top of said stator, wherein such outlet can be connected to a tall chimney to exclude said gas outside such device, and wherein such gas outlet can contain a valve that allows only the passage of gas through it. The device of the first preferred embodiment further comprises a liquid outlet 11 preferably positioned at the lower side of said stator 1; wherein said liquid is excluded outside such device after being cooled by said gas.

In the first preferred embodiment of the present invention, said cool gas enters said device from said gas inlet 8, and said hot liquid enters said device from said hot liquid inlet 9. As said gas fills said compartments 4, and after being expanded by the heating effect caused by the higher temperature liquid, such liquid will be purged outside said compartments and fills the space between said rotor 2 and said stator 1; wherein such filling and purging takes place through said rectangular openings 5. Thus, said compartments will lose total density and will be pushed by gravity in buoyancy up, starting a useful vortex and rotating said rotor 2. When each of said compartments 4 reaches the up position, it gets rid of the gas found in it through said gas outlet 10, and the trapped liquid between said stator 1 and said rotor 2 fills the compartments from which the gas is excluded, thus, gaining total density and starting the down gravity cycle until they reach the down position to be filled again with said cool gas through said cool gas inlet 8.

The second preferred embodiment of the present invention comprises a donut-shaped stator 1; wherein such stator represents the casing of the device; and wherein a continuous donut-shaped rotor 2 is engulfed by such stator 1 with a small space between them. Such rotor is equally divided by separating walls 3 into a plurality of compartments 4; wherein such compartments are adjacent to each other such that the end of one compartment is the beginning of the adjacent compartment; and wherein such compartments 4 have rectangular openings 5 on the outside circumference of said rotor 2. Such openings 5 permit the flow of gas and liquid into and out of said compartments 4; wherein such openings have window-type power pickups 6 with hinges that open towards said rotor 1; wherein the cross section of such pickups is perpendicular to the direction of such openings 5. Such pickups are rigged to close automatically just before touching a plurality of rollers 7 or when said rotor 2 is faster than the created vortex, while such pickups open automatically when such vortex is faster than said rotor 2. Said rollers 7 maintain said space between said stator 1 and said rotor 2 in order to avoid collision between such stator and such rotor. Said separating walls 3 have curved engineered shape; wherein such shape adopts the high efficiency of such embodiment. The second preferred embodiment of the present invention also comprises a cool gas inlet 8 positioned at the bottom of said stator 1; and hot liquid inlet 9 preferably positioned at the bottom of said stator 1; as well as a gas outlet 10 placed at the top of said stator, wherein such outlet can be connected to a tall chimney to exclude said gas outside such device, and wherein such gas outlet can contain a valve that allows only the passage of gas through it. The device of the second preferred embodiment also comprises a liquid outlet 11 preferably positioned at the lower side of said stator 1; wherein said liquid is excluded outside such device after being cooled by said gas. The second preferred embodiment further comprises a bypass 12 encircling the right side of said donut-shaped stator 1; wherein such bypass allows the bypass of said liquid towards a further route away from said rotor 2 through splitting the down cycle channel and allowing said liquid to jump over a protecting arrangement such as a brush 13 further towards said bypass 12; allowing said liquid to go down in it rather than going with said compartments 4, thus, increasing the inertia benefits till the flow joins again the vortex on the lower side of such device. Lower carbon brushes 14 are added to the area at which said liquid leaves said bypass 12 and re-enters said stator 1.

In the second embodiment of the present invention, said cool gas enters said device from said gas inlet 8, and said hot liquid enters said device from said hot liquid inlet 9. As said gas fills said compartments 4, after being expanded by the heating effect caused by the higher temperature liquid, such liquid will be purged outside said compartments and fills the space between said rotor 2 and said stator 1; wherein such filling and purging takes place through said rectangular openings 5. Thus, said compartments will lose total density and will be pushed by gravity in buoyancy up, starting a useful vortex and rotating said rotor 2. When each of said compartments 4 reaches the up position, it gets rid of the gas found in it through said gas outlet 10, and the trapped liquid between said stator 1 and said rotor fills the compartments from which the gas is excluded, thus, gaining total density and starting the down gravity cycle until they reach the down position to be filled again with said cool gas through said cool gas inlet 8; wherein said brush arrangement 13 restricts (skims) said liquid from going down with said compartments 4 when each of such compartments is in the upper position, and forces said liquid to go down through said bypass 12; and wherein said lower carbon brushes 14 prevent said liquid from going back into said bypass 12 at the bottom of said stator 1, or going back towards the compartments' sides falling in the down cycle.

The third embodiment of the new present invention comprises a donut-shaped stator 1; wherein such stator represents the casing of the device; and wherein a continuous donut-shaped rotor 2 is engulfed by such stator 1 with a small space between them. Such rotor is equally divided by separating walls 3 into a plurality of compartments 4; wherein such compartments are adjacent to each other such that the end of one compartment is the beginning of the adjacent compartment; and wherein such compartments 4 have rectangular openings 5 on the outside circumference of said rotor 2. Such openings 5 permit the flow of gas and liquid into and out of said compartments 4; wherein such openings have window-type power pickups 6 with hinges that open towards said stator 1; wherein the cross section of such pickups is perpendicular to the direction of such openings 5. Such pickups are rigged to close automatically just before touching a plurality of rollers 7 or when said rotor 2 is faster than the created vortex, while such pickups open automatically when such vortex is faster than said rotor 2. Said rollers 7 maintain said space between said stator 1 and said rotor 2 in order to avoid collision between such stator and such rotor. Said separating walls 3 have curved engineered shape; wherein such shape adopts the high efficiency of such embodiment. The third preferred embodiment of the present invention also comprises a cool gas inlet 8 positioned at the bottom of said stator 1; and hot liquid inlet 9 preferably positioned at the bottom of said stator 1, as well as a gas outlet 10 placed at the top of said stator, wherein such outlet can be connected to a tall chimney to exclude said gas outside such device, and wherein such gas outlet can contain a valve that allows only the passage of gas through it. The device of the third preferred embodiment also comprises a liquid outlet 11 preferably positioned at the lower side of said stator 1; wherein said liquid is excluded outside such device after being cooled by said gas. The third embodiment further comprises a plurality of steam or water jets; wherein such jets are directed through intentionally-angled pipes 15 propelling pressurized steam; and wherein such pipes 15 are directed towards the outside body of said compartments 4 from the back, and the two lateral sides of said stator 1. One way direction flappers 16 with carbon brushes are added to the inner walls of said stator 1 at the places where said pipes 15 meet the body of said stator; wherein such flappers are mechanically connected to valves such that such valves open when such flappers are open in order to propel steam. Said flappers open when there is steam being propelled through said pipes 15 or when said liquid in the vortex attempts to go in an opposite direction of rotation of said rotor.

In the third preferred embodiment of the present invention, said cool gas enters said device from said gas inlet 8, and said hot liquid enters said device from said hot liquid inlet 9. As said gas fills said compartments 4, and after being expanded by the heating effect caused by the higher temperature liquid, such liquid will be purged outside said compartments and fills the space between said rotor 2 and said stator 1; wherein such filling and purging take place through said rectangular openings 5. Thus, said compartments will lose total density and will be pushed by gravity in buoyancy up, starting a useful vortex and rotating said rotor 2. When each of said compartments 4 reaches the up position, it gets rid of the gas found in it through said gas outlet 10, and the trapped liquid between said stator 1 and said rotor fills the compartments from which the gas is excluded, thus, gaining total density and starting the down gravity cycle until it reaches the down position to be filled again with said cool gas through said cool gas inlet 8. During such mechanism, pressurized water steam is propelled in intentionally-angled directions through said pipes 15; wherein the use of such pressurized steam strengthens said vortex and heats said liquid; and wherein the angled orientation of said pipes 15 with a special pressure of said propelled steam helps the one way flow.

The fourth preferred embodiment of the present invention comprises a donut-shaped stator 1; wherein such stator represents the casing of the device; and wherein a continuous donut-shaped rotor 2 is engulfed by such stator 1 with a small space between them. Such rotor is equally divided by separating walls 3 into a plurality of compartments 4; wherein such compartments are adjacent to each other such that the end of one compartment is the beginning of the adjacent compartment; and wherein such compartments 4 have rectangular openings 5 on the outside circumference of said rotor 2. Such openings 5 permit the flow of gas and liquid into and out of said compartments 4; wherein such openings have window-type power pickups 6 with hinges that open towards said stator 1; wherein the cross section of such pickups is perpendicular to the direction of such openings 5; and wherein such pickups are rigged to close automatically just before touching a plurality of rollers 7 or when said rotor 2 is faster than the created vortex, while such pickups open automatically when such vortex is faster than said rotor 2. Said rollers 7 maintain said space between said stator 1 and said rotor 2 in order to avoid collision between such stator and such rotor. Said separating walls 3 have curved engineered shape; wherein such shape adopts the high efficiency of such embodiment. The fourth preferred embodiment of the present invention also comprises a cool gas inlet 8 positioned at the bottom of said stator 1; and hot liquid inlet 9 preferably positioned at the bottom of said stator 1; as well as a gas outlet 10 placed at the top of said stator, wherein such outlet can be connected to a tall chimney to exclude said gas outside such device, and wherein such gas outlet can contain a valve that allows only the passage of gas through it. The device of the fourth preferred embodiment also comprises a liquid outlet 11 preferably positioned at the lower side of said stator 1; wherein said liquid is excluded outside such device after being cooled by said gas. The fourth preferred embodiment further comprises a bypass 12 encircling the right side of said donut-shaped stator 1; wherein such bypass allows the bypass of said liquid towards a further route away from said rotor 2 through splitting the down cycle channel and allowing said liquid to jump over a protecting arrangement such as a brush 13 further towards said bypass 12; allowing said liquid to go down in it rather than going with said compartments 4, thus, increasing the inertia benefits till the flow joins again the vortex on the lower side of such device. Lower carbon brushes 14 are added to the area at which said liquid leaves said bypass 12 and re-enters said stator 1. The fourth embodiment further comprises a plurality of steam or water jets; wherein such jets are directed through intentionally-angled pipes 15 propelling pressurized steam; and wherein such pipes 15 are directed towards the outside body of said compartments 4 from the back, and the two lateral sides of said stator 1. One way direction flappers 16 with carbon brushes are added to the inner walls of said stator 1 at the places where said pipes 15 meet the body of said stator; wherein such flappers are mechanically connected to valves such that such valves open when such flappers are open in order to propel steam. Said flappers open when there is steam being propelled through said pipes 15 or when said liquid in the vortex attempts to go in an opposite direction of rotation of said rotor 2.

In the fourth preferred embodiment of the present invention, said cool gas enters said device from said gas inlet 8, and said hot liquid enters said device from said hot liquid inlet 9. As said gas fills said compartments 4 after being expanded by the heating effect caused by the higher temperature liquid, such liquid will be purged outside said compartments and fills the space between said rotor 2 and said stator 1; wherein such filling and purging take place through said rectangular openings 5. Thus, said compartments will lose total density and will be pushed by gravity in buoyancy up, starting a useful vortex and rotating said rotor 2. When each of said compartments 4 reaches the up position, it gets rid of the gas found in it through said gas outlet 10, and the trapped liquid between said stator 1 and said rotor fills the compartments from which the gas is excluded, thus, gaining total density and starting the down gravity cycle until they reach the down position to be filled again with said cool gas through said cool gas inlet 8; wherein said brush arrangement 13 restricts (skims) said liquid from going down with said compartments 4 when each of such compartments is in the upper position, and forces said liquid to go down through said bypass 12; and wherein said lower carbon brushes 14 prevent said liquid from going back into said bypass12 at the bottom of said stator, or going back towards the compartments' sides falling in the down cycle. During such mechanism, pressurized water steam is propelled in intentionally-angled directions through said pipes 15; wherein the use of such pressurized steam strengthens the vortex and heats said liquid; and wherein the angled orientation of said pipes 15 with a special pressure of said propelled steam helps the one way flow.

A well-balanced calibrated positive gas pressure is maintained to keep the gas pressure filling the lower area without overfilling with gas pressure and over flowing, or going lower than needed to keep the minimum liquid escaping into the area in the pipe engine, where liquid-filled compartments are going down by gravity creating more torque.

In the four preferred embodiments of the present invention, the denser and hotter the entering liquid is, and the cooler the propelled gas is, the more efficient the device will be. According to heat transfer rules, the hot liquid will be cooled down inside such device and excluded outside such device through said liquid outlet 9, and said cool gas will be heated by said hot liquid.

The gravity bolstered vortex engine device of the present invention can be used as a pump by closing said gas outlet 10, and at the same time by allowing said gas to go from the upper compartment to the lower compartment of said compartments 4 through one-way valves added to said compartments 4; wherein such valves are oriented towards a direction opposite to the rotation of the rotor; and wherein liquid-only valves will automatically open in order to allow the liquid in the vortex to enter said upper compartments through said compartments' openings 5. Also, to achieve such feature, another valve at the lower side of the lowest compartment must simultaneously open; wherein the entering liquid will be centrifuged out and said gas is sucked out transmitting the lower pressure to said upper compartment. Restrictors, such as venturi, can be put at the inner walls of said stator 1 around said upper compartment liquid receiving area; wherein such restrictions raise the pressure of the liquid in the upper area, thus, helping in pushing said gas to said lower compartment.

Also, said gravity bolstered vortex engine device of the present invention can be used as a pump by putting a circular plenum with one-way valves to send said gas from said upper compartment to said lower compartment through valve scheduling into said compartments 4. Said upper compartment's valve will open at the same time carrying said gas from said upper compartment to said lower compartment. Said circular plenum should be refrigerated and insulated from the liquid around it. Said gas passing through said plenum cools down as it runs through such plenum. By the time such gas reaches said lower compartment, it enters and resides inside such compartment and becomes inflated as a result of heat exchange with said hotter liquid which surrounds such compartment; wherein such heat exchange increases the efficiency of the working compartment by changing heat into immediate torque. In the hot side of this refrigeration system, heat is drawn from said plenum causing it to cool down. Also, the heat generated from the running compressor and from the compression process is transferred to a non-insulated pipe located at the opposite side of said rotor 2. Such transferring action heats-up the overall working liquid residing and rotating inside said stator 1, which enables said compressor to cool down causing the device to become more efficient. In addition, a scheduled valve at each of said rectangular openings 5 can also be added such that the valve at said rectangular opening at said lower compartment is scheduled to open in order to centrifuge the liquid inside said lower compartment and closes when all liquid inside said lower compartment is centrifuged outside said lower compartment. During the centrifugation process, the gas inside said plenum is sucked out, and thus the efficiency of this pump is increased.

Torque can be retrieved from the upper side of said device through gears connected through the upper side of said stator onto said rotor 2 taking from the lower liquid pressure area.

When the device is used to generate electricity, the fact that such device has a donut shape can be very useful for any electromagnetic generation system built directly on and around said device itself; such configuration will bare much lower cost and higher power efficiency than any other configuration in which the device is connected to an outside generator.

The device of the four preferred embodiments can be oriented in a direction such that it enables the created vortex to pick up from the Coriolis Effect, which will increase the efficiency of such device.

While the invention has been described in details and with reference to specific embodiments thereof, it will be apparent to one skilled in the art that various additions, omissions and modifications can be made without departing from the spirit and scope thereof.

Although the above description contains many specificities, these should not be construed as limitations on the scope of the invention but is merely representative of the presently preferred embodiments of this invention. The embodiment(s) of the invention described above is (are) intended to be exemplary only. The scope of the invention is therefore intended to be limited solely by the scope of the appended claims.

1. A device for energy recycling using gravity in buoyancy as a motivator when a gas source is released into a liquid; said device operating as a pump, said device comprising a casing consisting of a donut-shaped stator, a donut-shaped rotor engulfed by said stator with a space between them upheld by separation means a hot liquid inlet, a cold liquid outlet, a cold gas inlet, and a hot gas outlet, wherein said rotor comprises a plurality of separating walls forming a plurality of adjacent curved compartments, each compartment having an opening to permit flow of liquid and gas inside and outside of said compartment, and wherein said opening has a window-type power pickups with hinges that open automatically when a generated liquid vortex is faster than said rotor and close automatically when said rotor is faster than said generated liquid vortex.

2. The device as claimed in claim 1, further comprising a bypass encircling a side of said stator with a plurality of restrictions for restricting the liquid from moving in certain directions.

3. The device as claimed in claim 2, further comprising a plurality of water or steam jets directed through a plurality of pipes with one way direction flappers.

4. The device as claimed in claim 3, wherein said device operates as a pump by allowing said gas to flow from an upper compartment to a lower compartment in a direction opposite to a direction of rotation of said rotor.

5. The device as claimed in claim 4, wherein said gas flows through a plurality of one-way valves directed towards the opposite direction of rotation of said rotor, and by opening liquid-only valves to allow liquid to flow into said upper compartments from the generated vortex through said compartments' openings.

6. The device as claimed in claim 5, further comprising restrictors located at the upper inner walls of said stator for increasing efficiency of said pump by increasing pressure in the upper area.

7. The device as claimed in claim 6, further comprising a circular plenum with one-way valves for enabling said gas to flow from said upper compartment to said lower compartment through valve scheduling into said compartments, and wherein said pipe is refrigerated and insulated from the liquid around it.

8. The device as claimed in claim 7, wherein the upper compartment and lower compartment valves are configured to open at the same time for carrying said gas from said upper compartment to said lower compartment.

9. The device as claimed in claim 8, wherein a non-insulated pipe connected to the hot side of the refrigeration system's compressor can be added to the opposite side of said rotor for heating the working liquid inside said stator and cools down such compressor and the hot side of the refrigeration system causing the device to become more efficient.

10. The device as claimed in claim 9, further comprising a scheduled valve at each of said openings.

11. The device as claimed in claim 10, wherein said valve at said lower compartment's opening is configured to open to centrifuge the liquid inside said compartment and to close when all liquid inside said compartment is centrifuged outside, and wherein the gas inside said plenum is sucked out, for increasing efficiency of the pump.

12. The device as claimed in claim 11, wherein said separation means for maintaining said space between said stator and rotor comprise rollers.

13. The device as claimed in claim 12, wherein a hot liquid enters said device through said hot liquid inlet and a cold gas enters said device through said cold gas inlet, wherein said cold gas leaves said device after being heated up through said hot gas outlet, and said hot liquid leaves said device after being cooled down through said cold liquid outlet.

14. The device as claimed in claim 13, wherein said hot liquid inlet, cold liquid outlet, and cold gas inlet are located at the bottom area of said stator, and said hot gas outlet is located at the top area of said stator.

15. The device as claimed in claim 14, wherein said restrictions comprise carbon brushes.

16. The device as claimed in claim 15, wherein said plurality of restrictions skims said liquid to flow through said bypass in the rotor's down-cycle rather than flowing down through said compartments.

17. The device as claimed in claim 16, wherein said restrictions prevent said liquid from going back into said bypass after leaving it at the bottom of the device, or from going back into the falling compartment sides.

18. The device as claimed in claim 17, wherein said plurality of water or steam jets propels pressurized water steam, wherein said plurality of water or steam jets are directed through said plurality of pipes towards the outside body of said compartments through intentionally-directed angles, said pressurized steam propelled by said steam or water jets strengthening said vortex and extra heating said hot liquid.

19. The device as claimed in claim 18, wherein said flappers have carbon brushes at their ends, said flappers being mechanically connected to steam jets valves' making such valves open in order to propel said pressurized steam when such flappers are open, and close in order not to propel said pressurized steam when such flappers are closed.

20. The device as claimed in claim 19, wherein said flappers open when pressurized steam is being propelled through said directing pipes, or when said liquid inside said vortex attempts to move in the opposite direction of said rotor's rotation, and close when there is no steam propelled through said directing pipes or when said liquid inside said vortex is moving in the same direction of the rotation of said rotor.
